(19) United States
(12) Patent Application Publication
(10) Pub. No.: US 2026/0238553 A1
(43) Pub. Date: Aug. 13, 2026

(54) METHODS, ARCHITECTURES, APPARATUSES AND SYSTEMS FOR ARTIFICIAL INTELLIGENCE MODEL DELIVERY IN A WIRELESS NETWORK

(71) Applicant: InterDigital CE Patent Holdings, SAS, Paris (FR)

(72) Inventors: Stephane Onno, SAINT GREGOIRE (FR); Gaëlle Martin-Cocher, Toronto (CA); Ahmed Hamza, Coquitlam, BC (CA)

(21) Appl. No.: 19/154,667

(22) PCT Filed: Feb. 9, 2024
(86) PCT No.: PCT/EP2024/053309

§ 371 Date: Aug. 7, 2025

(30) Foreign Application Priority Data
Feb. 10, 2023 (EP) 23315026.7
Jan. 22, 2024 (EP) 24305126.5

(51) Int. Cl. H04L 41/16

(52) U.S. Cl. CPC H04L 41/16

(57) ABSTRACT

Procedures, methods, architectures, apparatuses, systems, devices, and computer program products for the distribution of Artificial Intelligence (AI) models from a network to a Wireless Transmit/Receive Unit (WTRU) in the network.

### CROSS-REFERENCE TO RELATED APPLICATIONS

This application claims the benefit of European Patent Application Nos. (i) 23315026.7 filed 10 Feb. 2023, and (ii) 24305126.5 filed 22 Jan. 2024; each of which is incorporated herein by reference.

### TECHNICAL FIELD

This disclosure pertains to procedures, methods, architectures, apparatus, systems, devices, and computer program products for, and/or directed to the distribution of Artificial Intelligence (AI) and/or machine learning (ML) models from a network to a Wireless Transmit/Receive Unit (WTRU) in the network.

### BACKGROUND

5G systems lack an architecture to provide an AI model. It would be beneficial to provide an architecture and associated methods for the distribution of an AI model from the network to a WTRU.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an AI/ML (Artificial Intelligence/Machine Learning) model diagram illustrating examples of different AI/ML subset compositions based on various split points;

FIG. 3 is a block diagram illustrating an example functional model distribution architecture in accordance with an embodiment;

FIG. 4 is a block diagram of a 5G AI model distribution system for downlink communication of an AI model;

FIG. 5 is a block diagram showing the components of an Inference Engine in a 5G AI model distribution system in accordance with an embodiment;

FIG. 6 is a block diagram showing the components of an AI model Session Handler in a 5G AI model distribution system in accordance with an embodiment;

FIG. 7 is a high level signal flow diagram illustrating an example of a progressive download for on-demand AI model content in accordance with embodiments;

FIGS. 8A and 8B are a signaling flow diagram describing a (e.g., high level) procedure for a progressive download of an AI model in a subset streaming/incremental loading mode in accordance with embodiments;

FIG. 9 is a block diagram showing the components for processing a neural network (NN) into a neural network representation (NNR);

FIG. 10 is a block diagram showing the components of a NNR bitstream;

FIG. 11 is a block diagram showing an example overview of a protocol stack;

FIG. 12 is a system diagram showing an example system using Dynamic Adaptive Streaming Over Hypertext Transfer Protocol (DASH) segmentation for AI model delivery;

FIG. 13 is a block diagram showing an example data structure for file delivery over unidirectional transport (FLUTE);

FIG. 14 is a block diagram showing an example protocol stack for real-time object delivery over unidirectional transport (ROUTE) DASH; and

FIG. 15 is a procedural diagram illustrating an example procedure for a WTRU 102 to download an AI model from a network.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

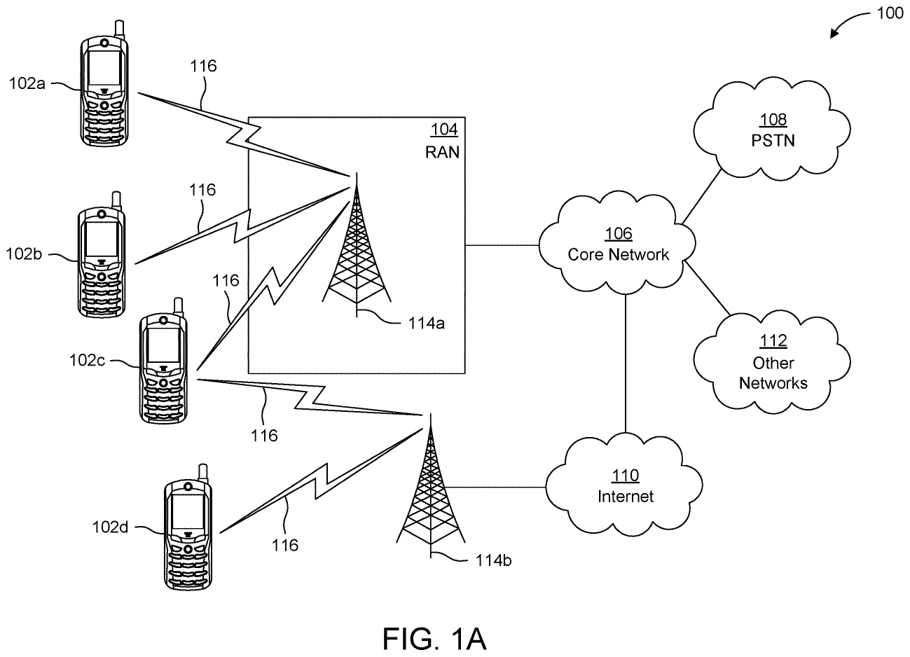

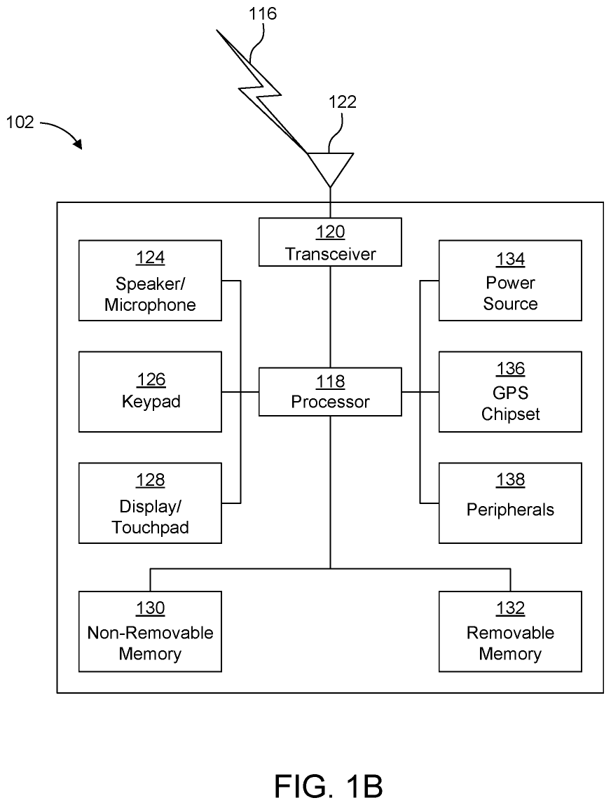

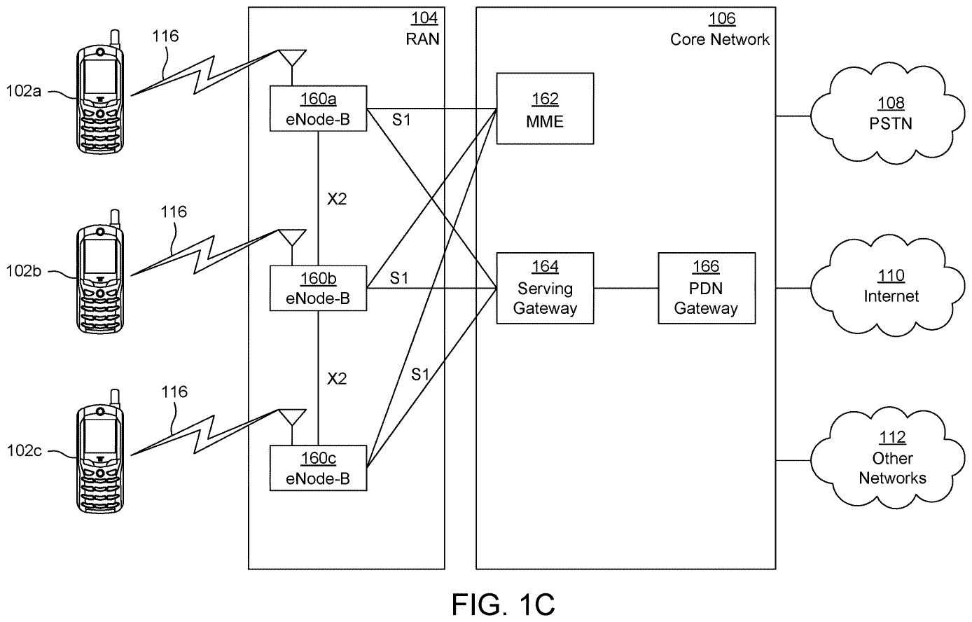

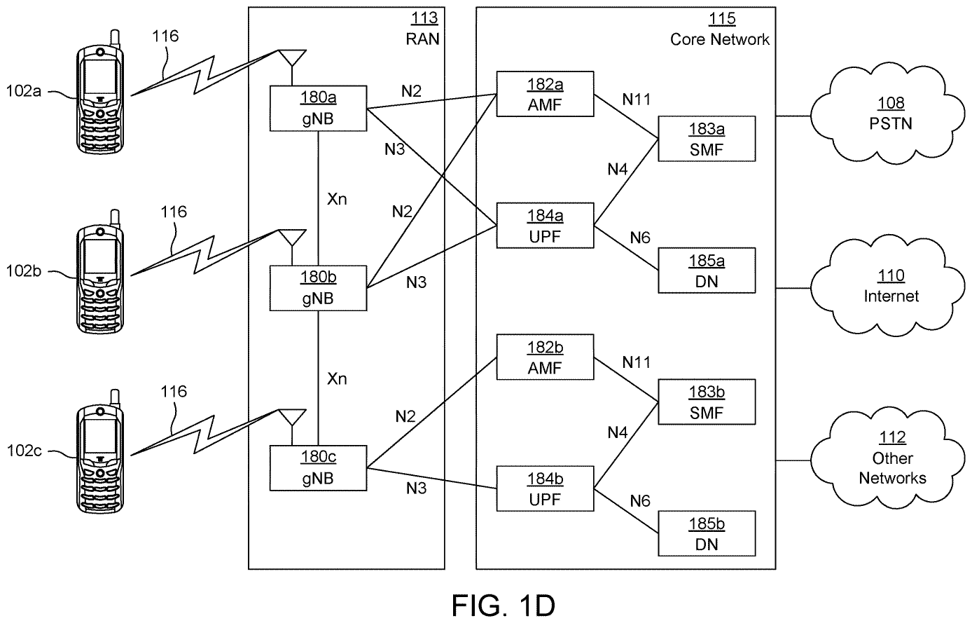

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114 b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QOS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

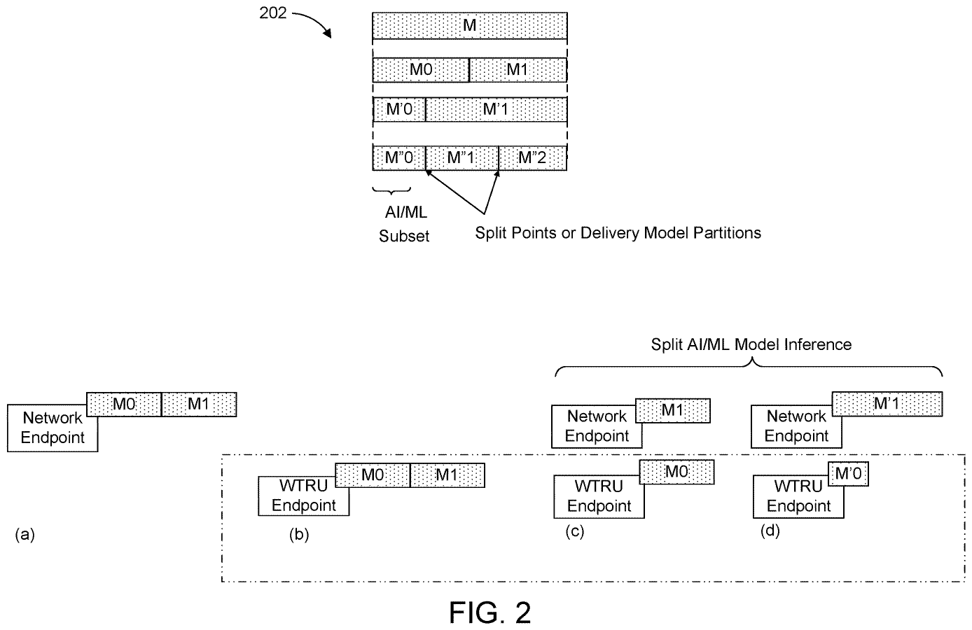

FIG. 2 is an AI/ML (Artificial Intelligence/Machine Learning) model diagram illustrating examples of different AI/ML subset compositions based on various split points. As shown in FIG. 2, several compositions 202 of a same AI/ML model M may be represented by the AI/ML subsets (M0, M1), (M′0, M′1), or (M″0, M″1, M″2). The same AI/ML subset may be used in different compositions depending on the configurations of the model composition (e.g., M′0 and M″0).

In certain representative embodiments, a set of subsets wherein some of the subsets in the set are running on different network nodes (e.g., different WTRUs) may be referred to as a split and/or distributed inference of the model. As can be seen with the various compositions 202, an AI model may have multiple different candidate split points. For example, the lines separating different subsets in FIG. 2 may represent delivery model partitions when each subset M0, M1, M2 is transmitted and inferenced (e.g., executed) in the same node (e.g., WTRU 102). A delivery model partition may define and/or refer to the boundary of a portion (e.g., subset) of the model that may be transmitted and executed as a unit independently of the other portions (e.g., subsets) of the overall model.

Examples (a) and (b) of FIG. 2 each show an example of an AI/ML inference node running an AI/ML model, M, composed of two subsets, M0 and M1. For example, a node (e.g., a network endpoint or a WTRU endpoint) may run the AI/ML model subset M0 while downloading the other subset M1.

In certain representative embodiments, a first subset (e.g., M0) may be requested (e.g., selected by a WTRU 102). The first subset may be received (e.g., by an inference engine executed by the WTRU 102). The received first subset may be used to obtain an (e.g., intermediate) inference result from the first subset, such as using given media content (e.g., an image, sequence of images, video, audio, text, and/or video) as an input to an inference that is performed using the first subset. For example, an inference engine of the WTRU 102 may execute the first subset while a second subset (e.g., M1) is requested (e.g., by the WTRU 102) for delivery. The second subset may be received (e.g., by an inference engine executed by the WTRU 102) and passed to the inference engine. The received second subset may be used to obtain an (e.g., intermediate) inference result from the inference engine executing the second subset, such as using the inference result (e.g., output from the execution of the inference using the first subset) as an input for the inference engine executing an inference using the second subset.

For example, an AI model file may be distinguished from a generic software file. The AI model file may be segmented and composed of different consecutively executable subsets where the output of a first inference (e.g., executed using the first subset) is used as the input to a second inference (e.g., executed using the second subset). In other words, an AI model file may be decomposable into plural consecutive loadable and runnable subsets, such as where an output from an inference executed using a respective subset is provided as an input to an inference executed using a next subset.

Examples (c) and (d) of FIG. 2 demonstrate AI/ML split models in which subsets M0, M′0 run on the WTRU while subsets M1, M1′ run on the network. For example, these configurations may be referred to as split AI/ML model inferences.

As described herein, the terms AI model, ML model, and AI/ML model may be used interchangeably.

At the present time, there is no detailed architecture for providing the downloading and/or streaming of AI models in 3GPP.

Accordingly, architectures, and components, and methods for the distribution of an AI model from a network to a WTRU 102 are desirable, including:
AI model data compositions and representations for distribution;
5G AI model distribution systems for downlink communications;
Procedures for progressive downloads (e.g., on demand) of full AI models;
Procedures for progressive downloads of AI Models with streaming and/or incremental model loading; and
Procedures for selecting a full AI model or an incremental AI model to be downloaded.

### AI Model Data Composition

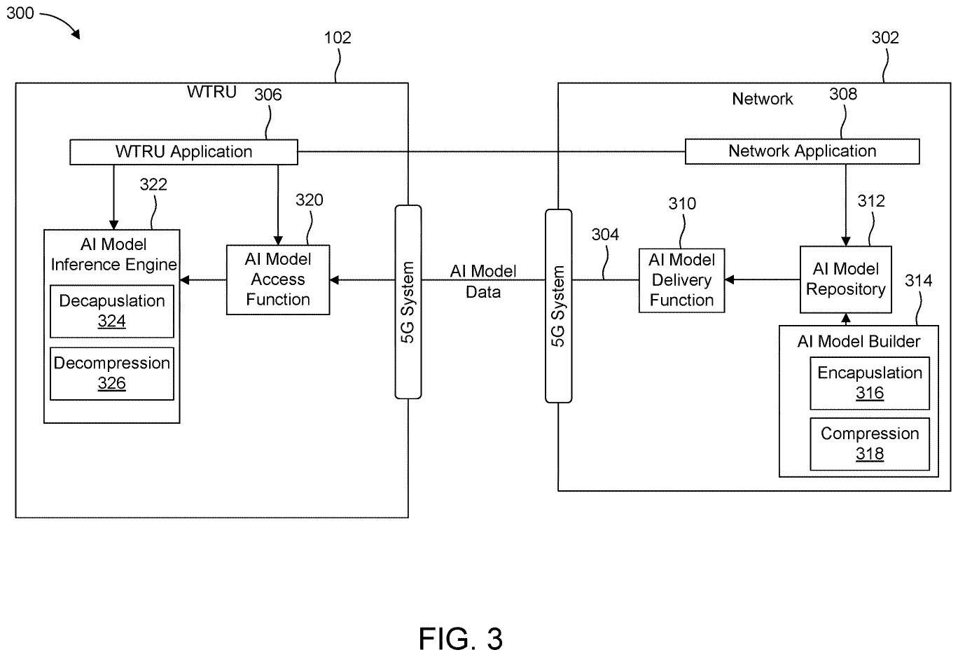

FIG. 3 is a block diagram illustrating an example functional model distribution architecture 300 in accordance with an embodiment. In FIG. 3, a WTRU 102 and a network 302 (e.g., RAN 113 and Core Network 115) may communicate to exchange AI model data 304. For example, the AI model may be associated with a WTRU application 306 and/or a network application 308.

In certain representative embodiments, an AI model delivery function 310 in the network may deliver the AI model data 304 (e.g., of an AI/ML model) from an AI model repository 312 to the WTRU 102 via the 5GS. For example, the AI model repository 312 may store a plurality of AI models and/or various compositions thereof which are received from an AI model builder 314. The AI model builder may include an encapsulation function 316 and/or a compression function 318.

In certain representative embodiments, an AI model access function 320 in the WTRU 102 may receive the AI model data 304 and feeds it to an AI model Inference Engine 322. For example, the AI model Inference Engine 322 may include a decapsulation function 324 and/or a decompression function 326 to complement the encapsulation function 316 and/or the compression function 318.

In certain representative embodiments, the AI Model data 304 may be partitioned into AI model subsets. An AI model subset may be structured or unstructured. For example, a structured AI model (e.g., subset) may contain the structure of the neural network (NN) model as well as the associated data used for inference (e.g., a finite set of DNN (Deep Neural Network) layers with the necessary DNN layer data). For example, an unstructured AI model may comprise pieces of model data which are divided (e.g., cut) into different data chunks which need aggregation to compose a structured AI model (e.g., subset).

In certain representative embodiments, the AI model Inference Engine 322 may download a structured AI model subset, load it in the memory 130 and/or 132 and run the subset (e.g., to obtain an intermediate result) before doing the same for (e.g., any) subsequent AI model subsets. For example, this may be referred to as incremental model loading with progressive downloading of an AI Model. For example, incremental model loading with progressive downloading may be (e.g., only) applicable to structured AI model subsets.

In certain representative embodiments, AI model data may be represented using different formats, such as ONNX (Open Neural Network Exchange) and NNEF (Neural Network Exchange Format).

In certain representative embodiments, AI model data may be compressed using different codecs, such as NNC (Neural Network Constructor). For example, the WTRU 102 and the network 302 may use common AI model data profiles to provide interoperability.

n certain representative embodiments, the compressed AI model data or the AI model data representation may be encapsulated using container formats such as ISO Base Media File Format (ISOBMFF). For example, additional file format structures (e.g., boxes/atoms) may need to be defined for the encapsulation of AI model data. These boxes may define metadata that enable parsers to easily extract the AI model data from the file. Moreover, in the case where a container file is carrying model data to be applied or used at different points in time, additional track types and associated metadata boxes may be defined.

When downloading AI model data, a sending entity may use Multipurpose Internet Mail Extensions (MIME) multi-part messages to encapsulate different AI model subsets and to signal to the receiving end that the received model data has different logical parts. Additional top-level media types may be defined for the AI model data.

### Architecture Components for AI Model Distribution

### 5G AI Model Distribution System for Downlink (5GAImDSd)

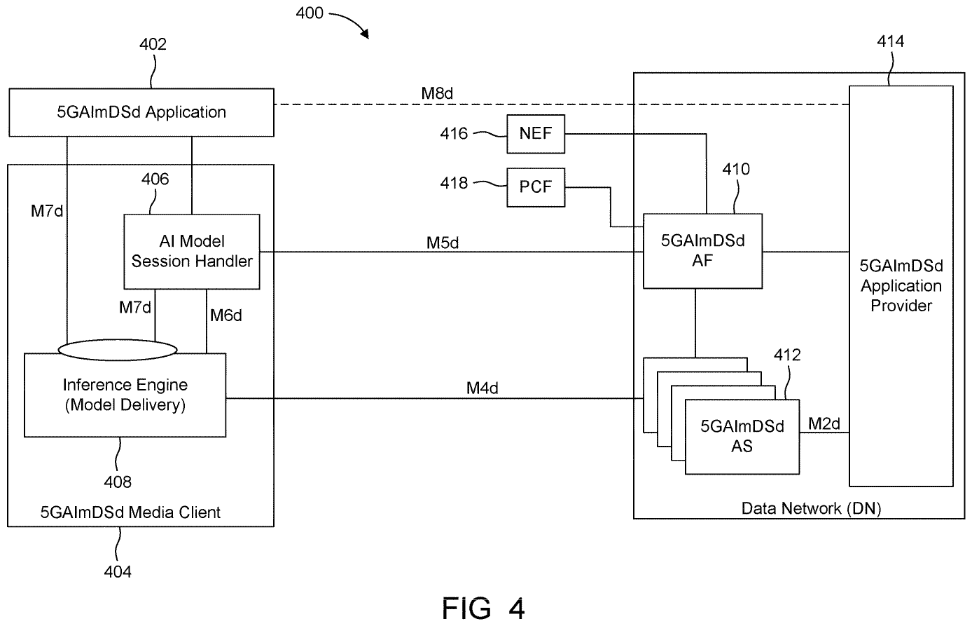

In certain representative embodiments, a 5G AI model distribution system may be used for downlink communication of an AI model. FIG. 4 is a block diagram of a 5G AI model distribution system 400 for downlink communication of an AI model.

In certain representative embodiments, a WTRU 102 may execute a 5GAImDSd Application 402 (e.g., an application that is to receive inference results from an AI model) and/or a 5GAImDSd Media Client 404. For example, the 5GAImDSd Media Client 404 may include two (sub)functions, namely: an AI model Session Handler 406 and an Inference Engine 408.

The AI model Session Handler 406 may be a (sub)function executed on the WTRU 102 that communicates with a 5GAImDSd Application Function (AF) 410 in the network in order to establish, control, and support the delivery of an AI model session. The AI model Session Handler 406 may perform additional functions such as consumption and QoE (Quality of Experience) metrics collection and reporting. The AI Model Session Handler 406 may expose one or more APIs that may be be used by the 5GAImDSd Application 402

The Inference Engine 408 may be a (sub)function executed on the WTRU 102 that communicates with the 5GAImDSd Application Server (AS) 412 in the network in order to get the model data and may provide APIs to the 5GAImDSd Application 402 for model data delivery and to the AI model Session Handler 406 for AI model session control.

The 5GAImDSd Application 402 may be an external AI media application. The 5GAImDSd Application 402 may control the 5GAImDSd AI Media Client 404 and may implement external application and/or content service provider specific logic and/or may allow an AI model session to be established. The 5GAImDSd Application 402 may not be defined within the 5G Technical Specification Group Service and System Aspects Working Group 4 (SA4) specifications, but the Application 402 or equivalent functions may make use of the 5G AI media client 404 and network functions using 5G model AI interfaces and APIs.

The 5GAImDSd Application Server (AS) 412 may be an Application Server that hosts 5G AI model functions. In certain representative embodiments, there may be different realizations of the 5GAImDSd AS 412, including the distribution of 5GAImDSd AS functionality between different physical hosts, such as in a Content Delivery Network (CDN).

In certain representative embodiments, Service Access Information may refer to a set of parameters and addresses that are used (e.g., needed) by a 5GAImDSd Media Client 404 to activate the (e.g., downlink) reception of an AI model streaming session. For example, the service access information may include one or ore AI model data entry points.

In certain representative embodiments, a Service and Content Discovery may refer to functionality and/or procedures provided by a 5GAImSd Application Provider 414 to a 5GAImDSd-Aware Application 402 that enables an end user to discover the available distribution service and content offerings and select a specific service or content item for access (e.g., a particular AI model).

In certain representative embodiments, a Service Announcement may refer to procedures conducted between the 5GAImDSd-Aware Application 402 and a 5GAImSd Application Provider 414 such that the 5GAImDSd-Aware Application 402 is able to obtain Service Access Information. For example, the 5GAImDSd-Aware Application 402 may obtain the Service Access Information (e.g., directly) from the 5GAImSd Application Provider 414. For example, the 5GAImDSd-Aware Application 402 may obtain a reference and/or a portion of the Service Access Information (e.g., directly) from the 5GAImSd Application Provider 414 and may obtain other (e.g., a remainder of the) Service Access Information from the 5GAImDSd AF 410.

In certain representative embodiments, the 5GAImDSd AS 412 may support and/or provide any of the following features: (i) ingesting an AI/ML model from a 5GAImDSd Application Provider 414 (e.g., at reference point M2d); (ii) caching AI/ML model content (e.g., to reduce the need to ingest the same content repeatedly at reference point M2d); (iii) a (e.g., generic) framework for AI model data preparation; (iv) domain name aliasing (e.g., at reference point M4d); (v) support for server certificates (e.g., at reference point M4d); (vi) URL path rewriting (e.g., at reference point M4d); and/or (vii) URL signing (e.g., at reference point M4d).

The 5GAImDSd Application Provider 414 may be an external application or content-specific AI media functionality (e.g., AI model creation, encoding and formatting) that uses the 5GAImDSd interfaces to distribute AI models to 5GAImDSd-aware applications 402.

The 5GAImDSd AF 410 may be an application function that provides various control functions to the AI Model Session Handler 406 on the WTRU 102 and/or to the 5GAImDSd Application Provider 414. It may relay and/or initiate a request for different Policy or Charging Function (PCF) 416 treatment or interact with other network functions via the Network Exposure Function (NEF) 418.

In certain representative embodiments, the following interfaces may defined for 5G downlink AI model distribution.

For example, the interface M1d (e.g., 5GAImDSd Provisioning API) may be an external API, exposed by the 5GAImDSd AF 410 which enables the 5GAImDSd Application Provider 414 to provision the usage of the 5G AI model distribution System for downlink AI/ML model data and/or to obtain feedback.

For example, the interface M2d (e.g., 5GAImDSd Ingest API) may be an optional external API exposed by the 5GAImDSd AS 412 used when the 5GAImDSd AS 412 in a (e.g., trusted) DN is selected to host content for the delivery service.

For example, the interface M3dmay be an internal (e.g., non-3GPP specified) API used to exchange information for content hosting on a 5GAImDSd AS 412 within the (e.g., trusted) DN.

For example, the interface M4d (e.g., Model distribution APIs) may be one or more APIs exposed by a 5GAImDSd AS412 to the Inference Engine 408 to deliver AI model data content.

For example, the interface M5d may be (e.g., Model data Session Handling API) one or more APIs exposed by a 5GAImDSd AF 410 to the AI/ML Model Session Handler 406 for model data session handling, control, reporting and assistance. One or more security mechanisms such as authorization and authentication may be supported and/or included.

For example, the interface M6d (e.g., WTRU AI media Session Handling APIs) may be one or more APIs exposed by an AI/ML Session Handler 406 to the Inference Engine 408 for client-internal communication. The interface M6d may be exposed to the 5GAImDSd-Aware Application 402 enabling it to make use of 5GAImDSd functions.

For example, the interface M7d (e.g., WTRU Inference Engine APIs) may be one or more APIs exposed by an Inference Engine to the 5GAImDSd-Aware Application 402 and AI Model Session Handler 406 to make use of the Inference Engine 408.

For example, the interface M8d (e.g., Application API) may be an application interface used for information exchange between the 5GAImDSd Aware Application 402 and the 5GAImDSd Application Provider 414. For example, the interface M8d may be used to provide Service Access Information to the 5GAImDSd-Aware Application 414. As an API, the interface M8d may be external to the 5G System and may not be specified by 5G media streaming (5GMS).

### WTRU 5GAImDSd Functions

In certain representative embodiments, the WTRU 102 may include one or more (sub)functions that may be used individually and/or controlled individually by the 5GAImDSd-Aware Application 402 (e.g., executed by the WTRU 102).

The 5GAImDSd-Aware Application 402 itself may include one or more (sub)functions that are not provided by the 5GAImDSd Client 404 or by the WTRU 102. Examples include service and AI model discovery, notifications, and social network integration. The 5GAImDSd-Aware Application 402 may also include functions that are equivalent to ones provided by the 5GAImDSd Media Client 404 and may only use a subset of the 5GAImDSd client functions. The 5GAImDSd-Aware Application 402 may act based on user input or may, for example, also receive remote control commands from the 5GAImDSd Application Provider 414 through M8d.

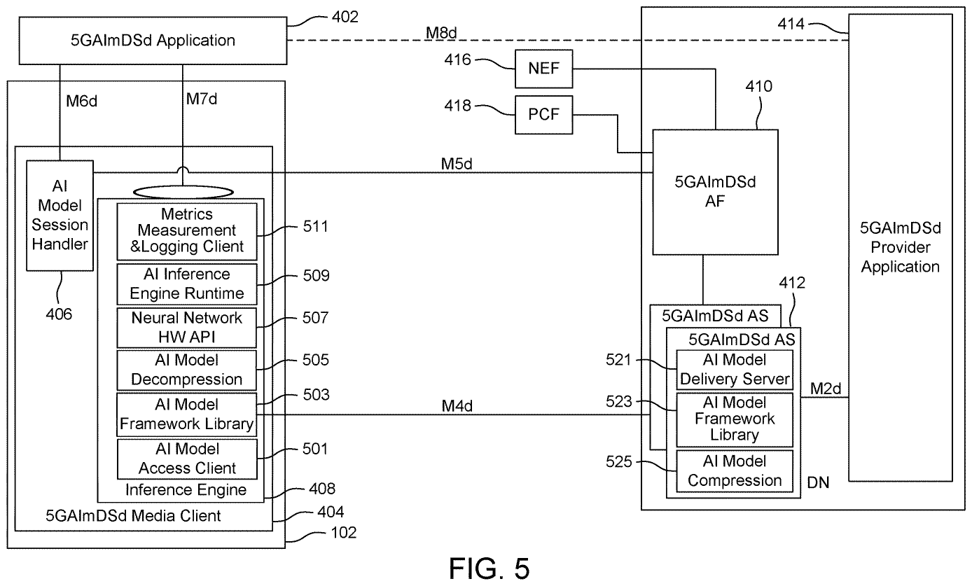

FIG. 5 is a block diagram showing the components of an Inference Engine in a 5G AI model distribution system in accordance with an embodiment. FIG. 5 shows functional components of the Inference Engine 408 for access to a 5GMSd AS 412. In certain representative embodiments, one or more of the following components may be provided by the Inference Engine 408.

For example, the Inference Engine 408 may include an AI model Access Client 501 which accesses AI model content for AI model subsets distribution, such as file-based AI model subsets or DASH-formatted AI model subsets.

For example, the Inference Engine 408 may include an Inference framework library 503 which may extract the (e.g., elementary) AI model data, such as the neural network model as well as the associated data used for inference.

For example, the Inference Engine 408 may include an AI model Decompression 505 function which may extract the (e.g., elementary) AI model data, such as when AI model data is compressed (e.g., using a neural network representation (NNR).

For example, the Inference Engine 408 may include a Neural Network Hardware API 507 which may provide acceleration for the Inference Engine 408 with supported hardware accelerators, such as any of a Graphics Processing Unit (GPU), Digital Signal Processor (DSP), Neural Processing Unit (NPU) or Central Processing Unit (CPU).

For example, the Inference Engine 408 may include a Metrics Measurement and Logging Client 511 which may perform the measurement and logging of QoE metrics in accordance with a Metrics Reporting Configuration part of provisioning data, supplied by the 5GAImDSd Application Provider 414 to the 5GAImDSd AF 410, and forwarded by the 5GAImDSd AF 410 to the Inference Engine 408 via the Media Session Handler 406.

For example, the Inference Engine 408 may include an AI Inference Engine Runtime 509 function that may feed and run the (e.g., decapsulated and decompressed) AI model data received from AI model Access Client 501.

In certain representative embodiments, one or more of the following components may be provided as part of an AI model AS 412.

For example, the 5GAImDSd AS 412 may include an AI model Delivery server 521 which may deliver AI model content for AI model subsets distribution, such as file-based AI model subsets or DASH-formatted AI model subsets.

For example, the 5GAImDSd AS 412 may include an Inference framework library 523 which may encapsulate the (e.g., elementary) AI model data, such as the neural network model as well as the associated data used for inference.

For example, the 5GAImDSd AS 412 may include an AI model Compression function 525 which may compress the (e.g., elementary) AI model data (e.g., using NNR).

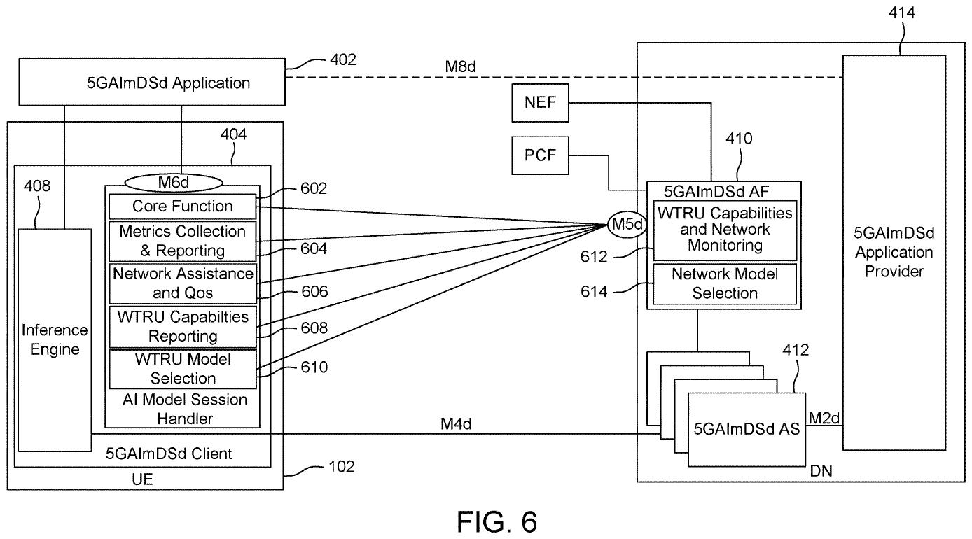

FIG. 6 is a block diagram showing the components of an AI model Session Handler in a 5G AI model distribution system in accordance with an embodiment. As shown in FIG. 6, f the AI Model Session Handler 406 accesses the 5GAImDSd AF 410. In certain representative embodiments, the AI Model Session Handler 406 may include one or more of the following components.

For example, the AI Model Session Handler 406 may include one or more Core Functions 602 for the realization of a “session” concept for media communications and may optionally span multiple stateless sessions. The Core Functions 602 may interact with the network-based 5GAImDSd AF 410.

For example, the AI Model Session Handler 406 may include a Metrics Collection and Reporting function 604 which may execute the collection of QoE metrics measurement logs from the Inference Engine 408 and send metrics reports to the 5GAImDSd AF 410 for the purpose of metrics analysis or to enable potential transport optimizations of the AI model data distribution by the network. Examples include model performance metrics include any (e.g., combination) of the following: (i) Model Accuracy, (ii) Model Precision, (iii) Model recall, (iv) Mean Square Error, and/or (v) Absolute Error.

For example, the AI Model Session Handler 406 may include a Network Assistance and QoS function 606 that coordinates the downlink distribution assisting functions provided by the network to the 5GAImDSd Client 404 and Inference Engine 408.

For example, the AI Model Session Handler 406 may include a WTRU capability reporting function 608 which may execute the monitoring of WTRU capabilities and reporting of the WTRU capabilities to a Network Monitoring Function 612 of the 5GAImDSd AF 410 for the purpose of AI model selection on the network side. Examples of WTRU capability information may include any (e.g., combination) of the following: (i) Available memory allocated for the AI/ML service, (ii) Processing capabilities available for the WTRU inference (e.g., of the CPU, GPU, TPU, and/or NPU), (iii) Energy consumption maximum available, (iv) Computing performance ability (e.g., floating-point operations per second or flops), (v) Current model inference latency, and/or (vi) WTRU location.

For example, the AI Model Session Handler 406 may include a WTRU Model Selection function 610 that may select the AI/ML models for different tasks, such as depending on WTRU capabilities and network conditions for a WTRU based selection mode. The WTRU Model Selection 610 may communicate with a Network Model Selection entity 614 of the 5GAImDSd AF 410, such as when the model selection is shared between the WTRU 102 and the network.

In certain representative embodiments, additional interfaces and/or APIs not shown in FIG. 6 may exist in inside the WTRU 102, such as any (e.g., combination) of the following: (i) AI model control interface(s) to configure and interact with the different WTRU AI model functions; (ii) AI model control interface for AI model session management; (iii) a control interface for collection of logged QoE metrics measurements; (iv) a control interface for collection of logged content consumption measurements; (v) handling of AI model data samples to the Inference Engine 408; and/or (vi) handling of decrypted, compressed AI model samples to a (e.g., trusted) AI model decoder.

In certain representative embodiments, the 5GAImDSd AF 410 may include any (e.g., combination) of the following: (i) a WTRU capabilities monitoring function for the monitoring of WTRU capabilities on the network side, such as via communications with the WTRU Capabilities Reporting function 608; and/or (ii) a network model selection function that selects the models for different tasks, such as depending on monitored WTRU capabilities, network conditions, and server side resources for the distribution of AI model to the WTRU 102. Selection of (e.g., available) AI models may be referred to as a network-based selection mode. When the selection is shared between the WTRU 102 and the network, the network model selection function may communicate with the WTRU Model Selection 610 function.

### Progressive Download of AI Model

### Full Model Progressive Download of a Full AI Model

In certain representative embodiments, a WTRU 102 may perform a procedure to establish a downlink session for streaming an AI model. For example, a streaming session may use the 3GP File Format (e.g., for progressive download), 3GP Timed Text, or other (e.g., non-3GPP) formats.

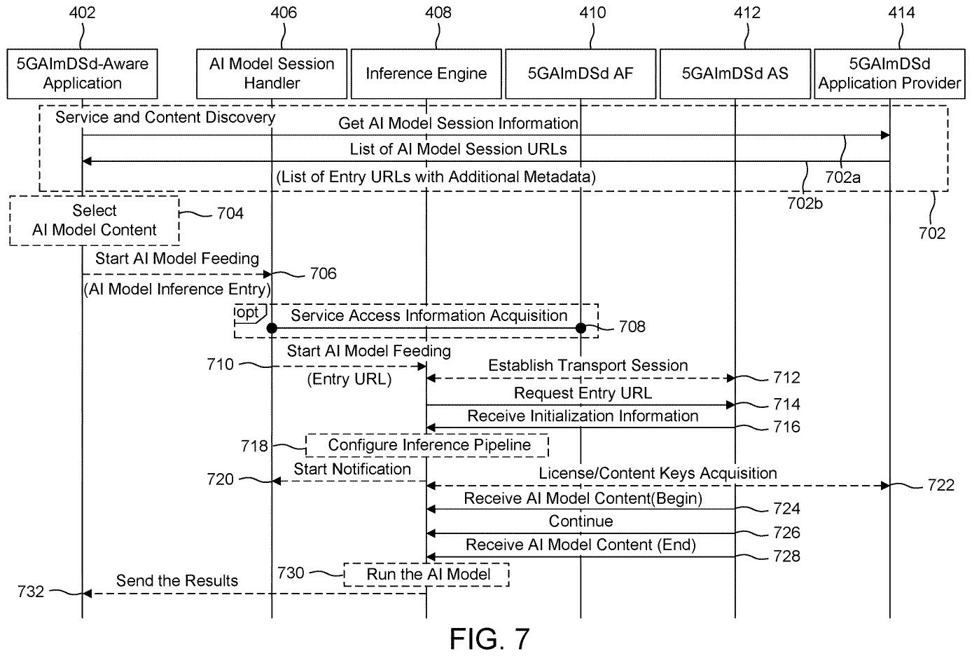

FIG. 7 is a high level signal flow diagram illustrating an example of a progressive download for on-demand AI model content in accordance with embodiments. For example, while not shown in FIG. 7, it maybe assumed that the 5GAImDSd Application Provider 414 has provisioned the 5G AI model distribution system for downlink and has set up content ingest, and that the 5GAImDSd-Aware Application 402 has received a service announcement from the 5GAImDSd Application Provider 414.

At 702, the 5GAImDSd-Aware Application 402 may trigger a Service Announcement and Service and Content Discovery procedure. The Service Announcement may include either the whole Service Access Information (e.g., details for AI model Session Handling, such as via interface M5d, and for AI model Streaming access, such a via interface M4d) or a reference to the Service Access Information.

For example, the 5GAImDSd-Aware Application 402 may request an AI model, such as by using a “Get AI model session information” message at 702a. The request may indicate whether or not the application requests a full model, a structured model, and/or any full/structured model compositions.

For example, the application provider 414 may provide and transmit (e.g., in response to the request), via the 5GAImDSd AS 412, a list of AI Models (e.g., AI Model Session URLs) with additional metadata including information on the types of the models (e.g. full and/or structured model types) at 702b. The list may comprise different AI/ML compositions including any full models and any structured models available to download. This may provide alternatives to the WTRU 102 to select a model depending on various WTRU capabilities or requirements.

For example, the WTRU 102 may select an AI/ML model based on any of the following: (i) evaluating internal capabilities (e.g., memory and/or processing power) to process a full or a part of a portion of a structured model; (ii) obtaining intermediate results before continuing to download additional portions of a structured model; and/or (iii) evaluating inference latency to obtain an early intermediate result or final result from inferencing a portion of a structured model or the full model itself.

For example, a list of a mixed composition of full models and structured models may include: (i) Full Model #1; (ii) Full Model #2; (iii) Structured Model #3 composition (e.g., adapted for incremental loading), such as Subset 1, Subset 2, Subset 3; and/or (iv) Structured Model #4 composition (e.g., adapted for incremental loading), such as Subset 1′, Subset 2′, Subset 3′.

In some representative embodiments, the Service and Content Discovery procedure at 702 may involve (e.g., only) the 5GAImDSd-Aware Application 402 and the 5GAImDSd Application Provider 412.

At 704, a full AI model, for example, may be selected among the list of candidate models obtained at 702. The selection may take into account any AI requirements regarding model performances achievable relative to the capabilities the WTRU 102 can or wants to allocate to running the AI model.

At 706, the 5GAImDSd-Aware Application 402 may trigger the AI model Session Handler 406 to start an inference. An Inference Engine entry may be provided to the AI model Session Handler 406. The application 402 may select or assist the Inference Engine 408 to select an inference entry from among the available inference processes running in the WTRU 102. The process may be an allocated TPU (Tensor Processing Unit), GPU (Graphical Processing Unit), CPU (Central Processing Unit) process, a software process, or a Virtual Machine instance running on the WTRU 102.

At 708, in some embodiments when the 5GAImDSd-Aware Application 402 has received only a reference to the Service Access Information at 702, the AI model Session Handler 406 may (e.g., optionally) interact with the 5GAImDSd AF 410 to acquire the whole Service Access Information. Among that information, the 5GAImDSd AF 410 may provide to the AI Model Session Handler 406 the AI model data encapsulation and/or compression format that are used (e.g., ONNX, NNEF, or NNC). In some embodiments, the 5GAImDSd AF 410 may provide (e.g., transmit) information on the model data composition regardless of whether the AI model subsets are structured or not.

At 710, the AI model Session Handler 406 may provide and transmit information indicating the model selection (e.g., the URL associated with the selected AI/ML model) to the 5GAImDSd AF 410. It may include information indicating the type of model being chosen (e.g., full or structured). If a structured model is chosen, the AI model Session Handler 406 may provide (e.g., transmit) information on the portion(s) of the structured model to download.

For example, depending on the capabilities and/or the requirements, the WTRU 102 may select the Structured Model #3 including Subset 1 and Subset 2 for the initial download.

For example, the WTRU 102 may evaluate an intermediate result (e.g., based on inferences using Subset 1 and Subset 2) prior to requesting the download of the Subset 3 (e.g., if needed).

At 710, the AI model Session Handler 406 may trigger the Inference Engine 408 to start the session.

At 712, the Inference Engine 406 may establish the transport session.

At 714, the Inference Engine 408 may send a request for the progressive download of the selected AI model content to the 5GAImDSd AS 412 in the network. For example, the request may include information indicating the selected AI model content (e.g., the URL associated with the selected AI/ML model)

At 716, the Inference Engine 408 may receive initialization information for the progressive download of the selected content from the 5GAImDSd AS 412. The initialization information may include configuration parameters for reception of the AI model and/or digital rights management (DRM) information.

At 718, the Inference Engine 408 may configure its pipeline for loading the AI model content for (e.g., further) inferencing.

At 720, the Inference Engine 408 may notify the AI model Session Handler 406, such as by providing the transport session information and (e.g., some) AI model content related information.

At 722, the Inference Engine 408 may (e.g., optionally) acquire a license and/or content keys from the 5GAImDSd Application Provider 414 to decrypt the AI model data.

At 724, the Inference Engine 408 may receive the AI model content. For example, the Inference Engine 408 may put the received AI model content into the rendering pipeline.

At 726, the Inference Engine 408 may (e.g., continue to) receive the AI model content. For example, the Inference Engine 408 may put each received part of the AI model content into the rendering pipeline (e.g., as they are received).

At 728, the Inference Engine 408 may receive the last part of the AI model content. The whole AI model may be received by the Inference Engine 408.

At 730, the Inference Engine 408 may run (e.g., execute) the AI model to obtain one or more (e.g., final) results.

At 732, the Inference Engine 408 may provide (e.g., send) the results obtained at 730 to the application 402.

### Model Streaming or Incremental Model Loading with Progressive Download of an AI Model

In certain representative embodiments, a WTRU 102 may perform a procedure to establish a downlink streaming session of one or more subsets of an AI model.

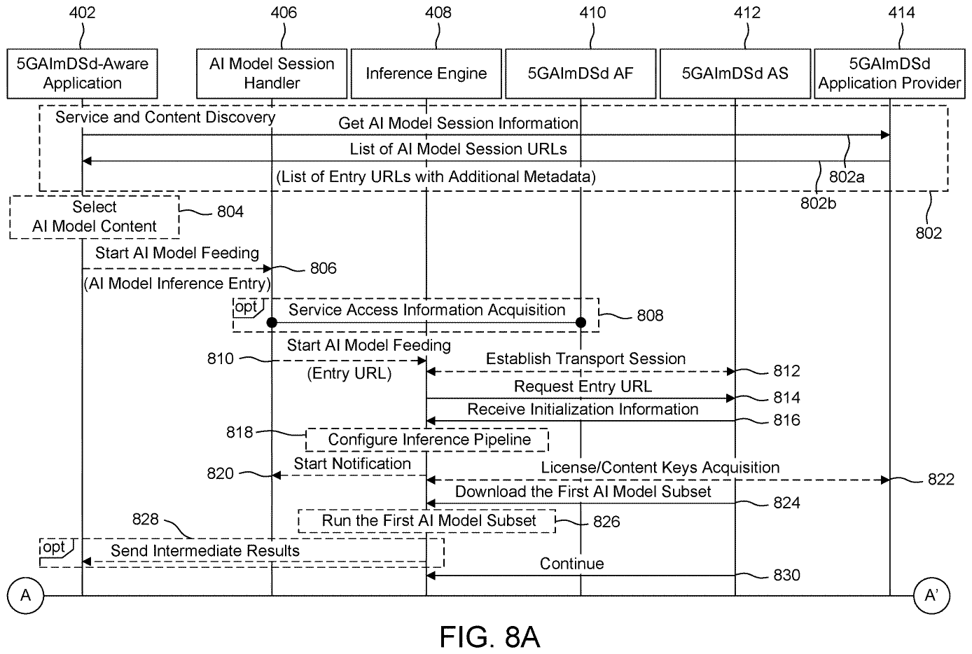

FIGS. 8A and 8B are a signaling flow diagram describing a (e.g., high level) procedure for a progressive download of an AI model in a subset streaming/incremental loading mode in accordance with embodiments. For example, while not shown in FIGS. 8A and 8B, it may be assumed that the 5GAImDSd Application Provider 414 has provisioned the 5G AI model distribution system for downlink and has set up content ingest, and that the 5GAImDSd-Aware Application 402 has received a service announcement from the 5GAImDSd Application Provider 414.

In certain representative embodiments, an AI model may be comprised of a set of AI model subsets. For example, the subsets may be organized in a linear sequence, such as where the output of one subset serves as the input for the next subset.

In FIGS. 8A and 8B, the (e.g., selected) AI model subsets are structured. In FIG. 7, the (e.g., selected) AI model is unstructured. As the AI model subsets are structured in FIGS. 8A and 8B, the Inference Engine 408 may start inferring (e.g., executing) each AI model subset and sending respective intermediate (e.g., partial) results to the 5GAImDSd-Aware Application 402 (e.g., immediately) upon reception and performing an inference using the AI model subset, instead of waiting for the full AI model to be downloaded before performing an inference using the full AI model (e.g., as in FIG. 7).

At 802, the 5GAImDSd-Aware Application 402 may trigger a Service Announcement and Service and Content Discovery procedure. The Service Announcement may include either the whole Service Access Information (e.g., details for AI model Session Handling, such as via interface M5d, and for AI model Streaming access, such a via interface M4d) or a reference to the Service Access Information.

For example, the 5GAImDSd-Aware Application 402 may request an AI model, such as by using a “Get AI model session information” message at 802a. The request may indicate that the application requests a structured AI model.

For example, the application provider 414 may provide and transmit (e.g., in response to the request), via the 5GAImDSd AS 412, a list of AI Models (e.g., AI Model Session URLs) with additional metadata including information on the types of the models (e.g. full and/or structured model types) at 802b. The list may comprise different AI/ML compositions including any full models and any structured models available to download. This may provide alternatives to the WTRU 102 to select a model depending on various WTRU capabilities or requirements.

For example, the WTRU 102 may select an AI/ML model based on any of the following: (i) evaluating internal capabilities (e.g., memory and/or processing power) to process a full or a part of a portion of a structured model; (ii) obtaining intermediate results before continuing to download additional portions of a structured model; and/or (iii) evaluating inference latency to obtain an early intermediate result or final result from inferencing a portion of a structured model or the full model itself.

In some representative embodiments, the Service and Content Discovery procedure at 802 may involve (e.g., only) the 5GAImDSd-Aware Application 402 and the 5GAImDSd Application Provider 412.

At 804, a structured AI model, for example, may be selected among the list of candidate models obtained at 802. The selection may take into account any AI requirements regarding model performances achievable relative to the capabilities the WTRU 102 can or wants to allocate to running the AI model.

At 806, the 5GAImDSd-Aware Application 402 may trigger the AI model Session Handler 406 to start an inference. An Inference Engine entry may be provided to the AI model Session Handler 406. The application 402 may select or assist the Inference Engine 408 to select an inference entry from among the available inference processes running in the WTRU 102. The process may be an allocated TPU (Tensor Processing Unit), GPU (Graphical Processing Unit), CPU (Central Processing Unit) process, a software process, or a Virtual Machine instance running on the WTRU 102.

At 808, in some embodiments when the 5GAImDSd-Aware Application 402 has received only a reference to the Service Access Information at 802, the AI model Session Handler 406 may (e.g., optionally) interact with the 5GAImDSd AF 410 to acquire the whole Service Access Information. Among that information, the 5GAImDSd AF 410 may provide to the AI Model Session Handler 406 the AI model data encapsulation and/or compression format that are used (e.g., ONNX, NNEF, or NNC). In some embodiments, the 5GAImDSd AF 410 may provide (e.g., transmit) information on the model data composition regardless of whether the AI model subsets are structured or not.

At 810, the AI model Session Handler 406 may provide and transmit information indicating the model selection (e.g., the URL associated with the selected AI/ML model) to the 5GAImDSd AF 410. It may include information indicating the type of model being chosen (e.g., structured). The AI model Session Handler 406 may provide (e.g., transmit) information on the portion(s) of the structured model to download.

For example, depending on the capabilities and/or the requirements, the WTRU 102 may select a structured model including a portion of all the subsets of the AI model for the initial download.

For example, the WTRU 102 may evaluate an intermediate result (e.g., based on inferences, such as using Subset 1 and Subset 2) prior to requesting the download of any subsequent subsets (e.g., Subset 3 if needed).

At 810, the AI model Session Handler 406 may trigger the Inference Engine 408 to start the session.

At 812, the Inference Engine 406 may establish the transport session.

At 814, the Inference Engine 408 may send a request for the progressive download of the selected AI model content to the 5GAImDSd AS 412 in the network. For example, the request may include information indicating the selected AI model content (e.g., the URL associated with the selected AI/ML model)

At 816, the Inference Engine 408 may receive initialization information for the progressive download of the selected content from the 5GAImDSd AS 412. The initialization information may include configuration parameters for reception of the AI model and/or digital rights management (DRM) information.

At 818, the Inference Engine 408 may configure its pipeline for loading the AI model content for (e.g., further) inferencing.

At 820, the Inference Engine 408 may notify the AI model Session Handler 406, such as by providing the transport session information and (e.g., some) AI model content related information.

At 822, the Inference Engine 408 may (e.g., optionally) acquire a license and/or content keys from the 5GAImDSd Application Provider 414 to decrypt the AI model data.

At 824, the Inference Engine 408 may download (e.g., receive) a first AI model subset and place the first AI model subset into the rendering pipeline.

At 826, the Inference Engine 408 may run (e.g., execute) the first AI model subset (e.g., even though the complete model is not yet downloaded). For example, media content, such as any of an image, sequence of images, video, audio, text and/or other data, may be provided as an input to the first AI model subset.

At 828, the Inference Engine 408 may send the intermediate results to the 5GAImDSd-Aware Application 402 (e.g., from running the first AI model subset). In some embodiments, the Inference Engine 408 may wait until the entire model (or any portion thereof) is run before sending any results to the 5GAImDSd-Aware Application 402.

At 830, the Inference Engine 408 may (e.g., continue to) receive the AI model subsets (e.g., in sequence). For example, the Inference Engine 408 may put each received AI model subset into the inference pipeline (e.g., as they are received).

For example, at 832, the Inference Engine 408 may download (e.g., receive) a Nth AI model subset and place the Nth AI model subset into the rendering pipeline. At 834, the Inference Engine 408 may run (e.g., execute) the N^{th} AI model subset (e.g., even though the complete model is not yet downloaded). For example, the N^{th} AI model subset may use an output from a previous (e.g., N-1^{th}) AI model subset as an input for performing inferencing to generate an intermediate result from the N^{th} AI model subset. At 836, the Inference Engine 408 may send the intermediate results (e.g., from running the N^{th} AI model subset) to the 5GAImDSd-Aware Application 402.

At 838, the Inference Engine 408 may (e.g., continue to) receive the AI model subsets (e.g., in sequence). For example, the Inference Engine 408 may put each received AI model subset into the rendering pipeline (e.g., as they are received).

At 840, the Inference Engine 408 may receive a last AI model subset. For example, the Inference Engine 408 may put each received AI model subset into the rendering pipeline (e.g., as they are received). For example, at 842, the Inference Engine 408 may run (e.g., execute) the last AI model subset, such as by using an output from the previous (e.g., penultimate) AI model subset.

At 844, the Inference Engine 408 may send a final result (e.g., from running the last AI model subset) to the 5GAImDSd-Aware Application 402. For example, the final result may correspond to an output of the last AI model subset where the output of the prior AI model subset was provided as an input to the last AI model subset.

### AI Model Format

In certain representative embodiments, an AI model may use any of Open Neural Network Exchange (ONNX) format, Neural Network Exchange Format (NNEF), and Neural Network Coding and Representation (NNR) format. In certain representative embodiments, an AI model may be subject to decomposition as follows.

For example, the ONNX format is built around a protocol buffer where an ONNX graph may be structured as a list of nodes that form an acyclic graph that describes the AI model. It may provide the metadata necessary for extra model completion. There is a large set of built-in operators describing node operation, including: (i) Math operators, such as Abs; (ii) DNN operators, such as Conv and LSTM; (iii) Activation operators, such Sigmoid and Relu; (iv) Pooling operators, such as MaxPool; and (v) Other operators, such as error computation and data reformatting operators.

For example, the NNEF format enables the encapsulation of both the structure of the neural network model (e.g., AI model) as well as the associated data used for inference. An NNEF container may include a textual file that describes the structure of the neural network described through a computational graph, such as as a directed graph including data or operations nodes. Operation nodes may have attributes that describe the exact computation that needs to be performed. Operations nodes may be composed together to produce more compound operations. The NNEF container may include a binary data file for each variable tensor. These files may be structured hierarchically into sub-folders associated with a corresponding operation. Each tensor may have different representations, such as matching a different quantized version. The NNEF container may include a quantization file that contains details about the quantization algorithm that is used for quantizing the exported tensors.

For example, a neural network compiler (NNC) (e.g., format) may specify a compressed representation format for neural network data and processes for its decoding. The NNC is composed of a toolbox which can be flexibly selected from. In particular, NNC defines data structures and syntax elements to support the following features: (i) packaging of NN data; (ii) signaling of metadata related to various methods of pre-processing for data reduction; (iii) compression of NN weights/tensor coefficients; and (iv) interoperability.

For example, NN data of different types may be packaged in neural network representation (NNR) units for access from a system or application layer. A NNR parameter set and NNR layer parameter set units may convey metadata and information related to the entire NN and individual NN layers, respectively. NNR topology units may contain information on the NN topology (e.g. the connections between layers/tensors). The actual tensor data may be conveyed in NNR quantized information and NNR compressed data units. NNR aggregate units may allow for combining of several NNR units of different types that are related.

For example, the metadata related to various methods of pre-processing for data reduction may be signaled. This may include parameters related to sparsification, pruning, low-rank decomposition, unification, batch norm folding, and local scaling.

For example, the compression of NN weights/tensor coefficients may use quantization and entropy coding. Tensor/weight coefficients may be signaled as raw data or quantized with different methods. Quantized coefficients may be binarized and entropy coded using a context adaptive arithmetic coder (e.g., DeepCABAC).

For example, interoperability with other exchanges (e.g. NNEF, ONNX) or native formats (e.g., PyTorch, TensorFlow) may be supported. The NNC may allow embedding of topology information of other formats into an NNR bitstream. The NNR units representing coded tensors/weights may be embedded in the containers of other formats.

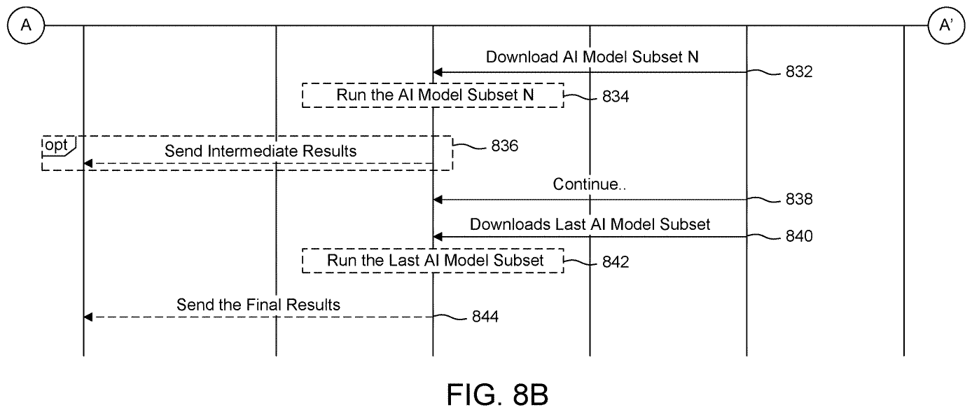

FIG. 9 is a block diagram showing the components for processing a NN into a NNR. As shown in FIG. 9, an (e.g., original) NN 902 may be processed into a NNR bitstream 904. For example, NN data representing the NNR may be provided to a pre-processing and/or parameter reduction processing unit 906, to a quantization processing unit 908, and/or to an entropy coding processing unit 910. For example, the pre-processing and/or parameter reduction processing unit 906 may include any of a sparsification function 912, a pruning function 914, a local scaling function 916, a LR-decomposition function 918, an unification function 920, and/or a batchnorm folding function 922. For example, the quantization processing unit 908 may receive as inputs the NN data and/or the outputs (e.g., NNR units) from the pre-processing and/or parameter reduction processing unit 906, and the quantization processing may include any of a uniform function 924, a codebook 926, and/or a dependent function 928. For example, the entropy coding processing unit 910 may receive as inputs the NN data and/or the outputs (e.g., NNR units) from the quantization processing unit 908, and may include any of a binarization function 930, a context modeling function 932, and/or an arithmetic coding function 934. The outputs (e.g., NNR units) from the pre-processing and/or parameter reduction processing unit 906, quantization unit 908, and/or entropy encoding processing unit 910 may form the NNR bitstream 904. In other examples, AI models other than a NN may be processed into a bitstream.

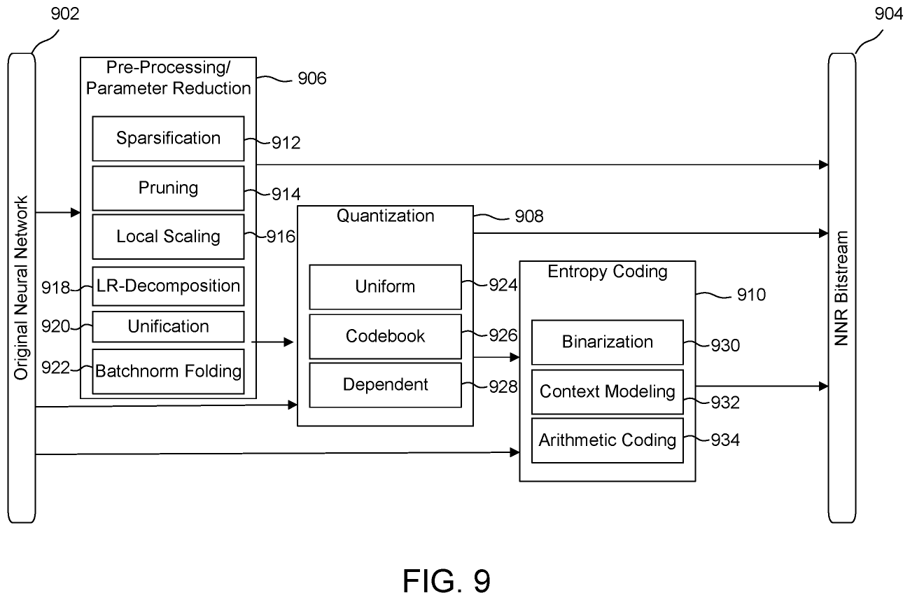

FIG. 10 is a block diagram showing the components of a NNR bitstream. As shown in FIG. 10, an NNR bitstream 904 may comprise a plurality of the NNR units 1002. As an example, a NNR unit 1002 may comprise information including any of a NNR unit size 1004, a NNR unit header 1006, and/or a NNR unit payload 1002.

### 3GP File Types

In certain representative embodiments, the 3GPP file format (3GP) may be used as an instance of the ISO base media file format.

In certain representative embodiments, the transfer of media content (e.g., AI model) to a receiving terminal may use file download, streaming, or Multimedia Broadcast/Multicast Service (MBMS) download delivery. In the first and last cases, a self-contained file may be transferred. In the second case, such as for Real-time Transport Protocol (RTP) streaming, the content may extracted from the file and streamed according to open payload formats. In this case, no trace of the file format remains in the content that is being transmitted (e.g., over the air/wireless interface).

In segmented streaming over DASH, a file may be divided into segments for transfer.

For example, the AI model may be a self-contained file download. The AI model composition may involve different AI Subsets that terminate at specific neural network boundaries.

### Progressive Download

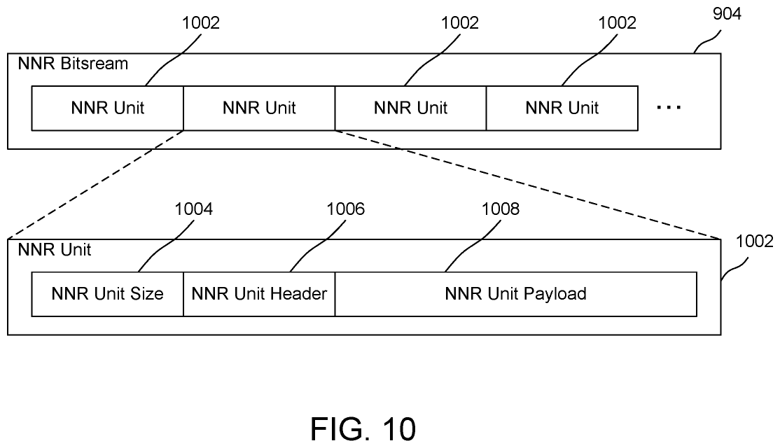

FIG. 11 is a block diagram showing an example overview of a protocol stack, such as may be used for services as described herein. As shown in FIG. 11, a protocol stack may include any of IP 1102, TCP 1104, HTTP 1106, a media presentation description 1108, 3GP file format 1110, and video formats, audio formats, speech formats, timed text formats, and/or AI model formats 1112.

In certain representative embodiments, 3GP files may be accessible using progressive downloading. In certain representative embodiments, segments based on the 3GPP File Format may be accessible through HTTP. For example, progressive downloading may provide for the partial transfer of 3GP files and/or segments (e.g., using HTTP with a header “application/3gpp-partial” in combination with an HTTP GET request).

In certain representative embodiments, progressive downloading may be used for the downloading of an AI model from the network to the WTRU 102.

In certain representative embodiments, a partial transfer can be used for the delivery (e.g., downloading) of AI model subset(s).

### Dynamic Adaptive Streaming Over Hypertext Transfer Protocol (DASH)

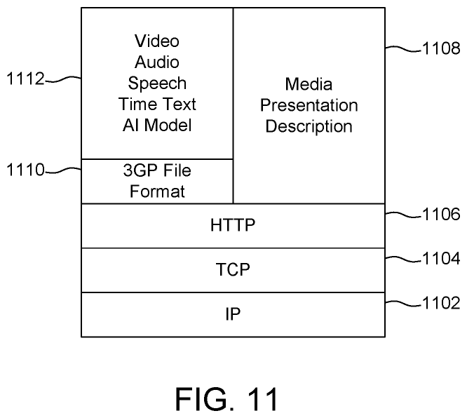

FIG. 12 is a system diagram showing an example system using DASH segmentation for AI model delivery. As shown in FIG. 12, a content server 1202 may communicate with a DASH client 1204 (e.g., executed by a WTRU 102) regarding transport protocol and may perform media presentation description (MDP) delivery. The content server 1202 may include a MDP unit 1206 and various AI models 1208 available for downloading. The DASH client 1204 may be provided with control heuristics 1210, a MPD parser 1212, a segment parser 1214, a transport access client 1216, and one or more media players 1218.

In certain representative embodiments, an AI model may be considered to be similar to a file.

In certain representative embodiments, DASH segmentation may be used to deliver an AI model composed of AI model data subsets. For example, the segmentation may be independent from AI model data composition as a bitstream of encapsulated, compressed and/or serialized AI model data chunks.

For example, a segmentation representation may provide a description of a closed group of AI model data or model subsets runnable by the AI model inference. For example, it may contain a finite set of DNN layers with the necessary DNN layer data.

### File Delivery Over Unidirectional Transport (FLUTE) for AI Model Access Client

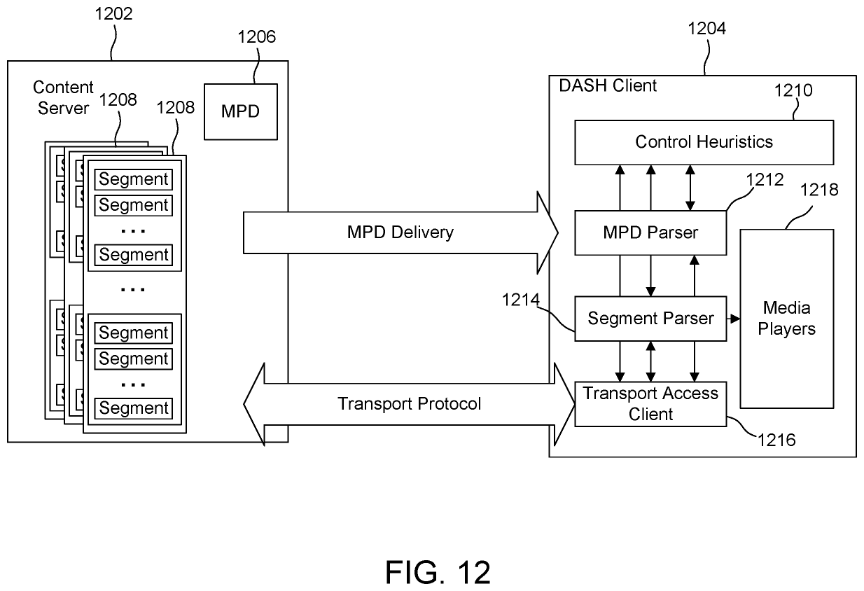

FIG. 13 is a block diagram showing an example data structure for FLUTE. As shown in FIG. 13, a transport unit 1300 may include a UDP header 1302, a default LCT header 1304, LCT header extensions 1306, a FEC payload ID 1308, and a FLUTE payload (e.g., encoding symbols) 1310. FLUTE provides for file delivery over unidirectional UDP-based transport. FLUTE may be used to optimize latency for file delivery. FLUTE may enable IP multicast in accordance with Reliable Multicast Transport (RMT).

However, FLUTE adds a delivery size overhead for providing an (e.g., additional) error correction technique used to detect and correct errors in the transmitted data known as Forward Error Code (FEC).

### Real-Time Transport Object Delivery Over Unidirectional Transport (ROUTE) DASH

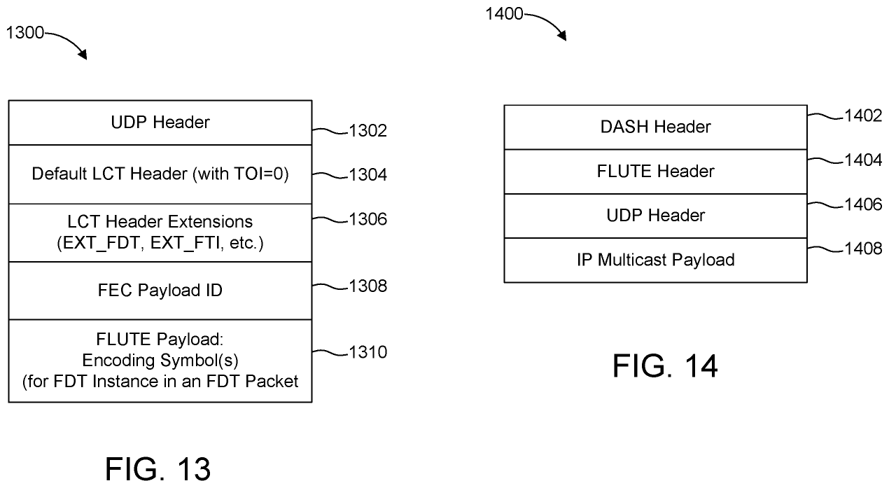

FIG. 14 is a block diagram showing an example protocol unit for ROUTE DASH. As shown in FIG. 14, a protocol unit 1400 may include a DASH header 1402, a FLUTE header 1404, a UDP header 1406, and an IP multicast payload 1408. For example, ROUTE DASH provides DASH segmentation above the unidirectional ROUTE protocol. It may also enable IP multicast delivery of DASH segments (e.g., an AI model subset). An application server acting as a carrousel multicast server may serve a large set of WTRUs 102 at the same time.

In certain representative embodiments, a large set of WTRUs 102 may want to download and run an AI model through a 5G link having limited network resources (e.g., crowded places and/or events). ROUTE DASH metadata and signaling may be optimized to provide real time delivery of the AI model(s).

### Representative Procedures

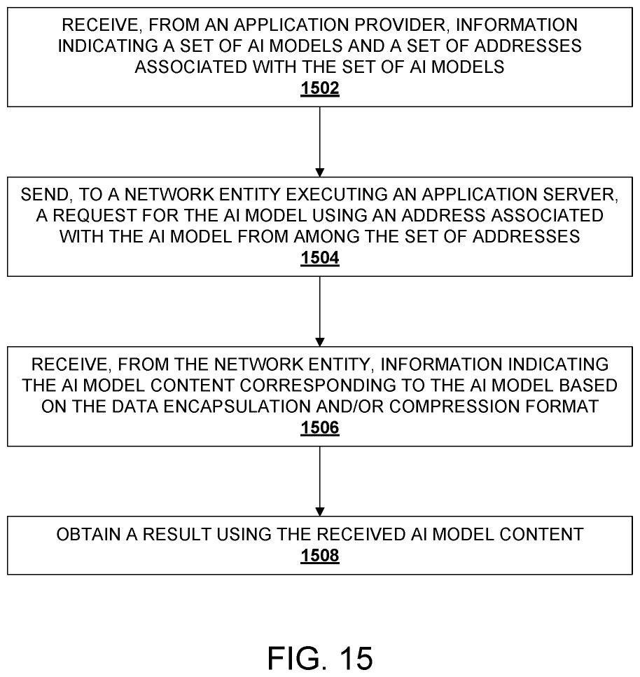

FIG. 15 is a procedural diagram illustrating an example procedure for a WTRU 102 to download an AI model from a network. As shown in FIG. 15, the WTRU 102 may receive, from an application provider, information indicating a set of AI models and a set of addresses associated with the set of AI models at 1502. At 1504, the WTRU 102 may send, to a network entity executing an application server, a request for an AI model (e.g., from among the set of AI models) using an address associated with the AI model from among the set of addresses. At 1506, the WTRU 102 may receive, from the network entity, information indicating the AI model content corresponding to the AI model. At 1508, the WTRU may obtain a result (e.g., full/final output of an inference) using the received AI model content.

In certain representative embodiments, the WTRU 102 may establish a (e.g., transport) session with a second network entity (e.g., executing an application function). For example, the AI model content may be received from the second network entity via the established session.

In certain representative embodiments, the AI model content may correspond to a full model of the AI model.

In certain representative embodiments, the WTRU 102 may configure an inference engine, executed by the WTRU 102, with the full model. The result at 1512 may be obtained from the configured inference engine.

In certain representative embodiments, the WTRU 102 may establish a (e.g., transport) session with a second network entity (e.g., executing an application function). For example, the AI model content may be received from the second network entity via the established session.

In certain representative embodiments, the AI model content may correspond to one or more subsets of the AI model.

In certain representative embodiments, the WTRU 102 may configure an inference engine, executed by the WTRU 102, with each subset of the AI model. For example, the WTRU 102 may obtain one or more intermediate results from the configured inference engine.

In certain representative embodiments, any (e.g., each) of the one or more intermediate results (e.g., from the inference engine) may be provided to an application executed by the WTRU 102.

In certain representative embodiments, the WTRU 102 may provide a final result (e.g., from the inference engine) to an application executed by the WTRU 102.

In certain representative embodiments, the WTRU 102 may receive a selection of the AI model from the set of AI models.

In certain representative embodiments, the WTRU 102 may receive, from the application provider, decryption information (e.g., content keys) associated with the AI model from an application provider. The WTRU 102 may decrypt the information indicating the AI model content using the decryption information.

In certain representative embodiments, the AI model content may include or be comprised of a plurality of dynamic adaptive streaming over hypertext transfer protocol (DASH) segments. For example, the WTRU 102 may aggregate the DASH segments to obtain the AI model.

In certain representative embodiments, the AI model content may include or be comprised of one or more AI model files. For example, the WTRU 102 may receive any (e.g., each) AI model file as a plurality of sequentially executable subsets.

In certain representative embodiments, the WTRU 102 may send, to a second network entity (e.g., executing an application function), information indicating an AI model (e.g., selected) from among the set of AI models.

In certain representative embodiments, the WTRU 102 may receive, from a second network entity (e.g., executing an application function), information indicating a data encapsulation and/or compression format associated with the AI model.

In certain representative embodiments, the WTRU 102 may receive the information indicating the AI model content as a bitstream.

In certain representative embodiments, the addresses received at 1502 may be uniform resource locators (URLs) respectively associated with the set of AI models.

In certain representative embodiments, a WTRU 102 may perform a procedure for (e.g., progressive) downloading of a (e.g., unstructured) AI model from a network. The WTRU 102 may execute an Inference Engine (IE). For example, the WTRU 102 may select, from a list of candidate AI models, an AI model for downloading from the network. The WTRU may trigger the IE to start a procedure for downloading the selected progressive AI model. The IE may establish a transport session with the network. The IE may transmit, to the network, a request for progressive downloading of the selected AI model. The IE may receive, from the network, a first portion of the selected progressive AI model and put the first portion of the selected AI model into a rendering pipeline. The IE may receive, from the network, a second portion of the selected AI model and put the second portion of the selected AI model into the rendering pipeline. The IE may receive, from the network, a final portion of the selected AI model and put the final portion of the selected AI model into the rendering pipeline. After the final portion of the selected AI model is received and put into the rendering pipeline, the IE may execute the selected AI model (e.g., to obtain an inference result).

In certain representative embodiments, the WTRU 102 may perform a Service Announcement and Service and Content Discovery procedure with the network to obtain at least one of Service Access information and AI model streaming access information.

In certain representative embodiments, the WTRU 102 may select the AI model for downloading as a function of the WTRU's capabilities to run AI models and/or functional requirements of the candidate AI models.

In certain representative embodiments, the WTRU 102 may, responsive to the request, receive initialization information of the selected AI model content. For example, the initialization information may include configuration parameters for reception of the selected AI model.

In certain representative embodiments, a WTRU 102 may perform a procedure for (e.g., progressive) downloading of a (e.g., structured) AI model from a network. The WTRU 102 may execute an Inference Engine (IE). For example, the WTRU 102 may select, from a list of candidate AI models, an AI model for downloading from the network. The WTRU 102 may trigger the IE to start a procedure for downloading the selected AI model. The IE may establish a transport session with the network. The IE may transmit a request for progressive downloading of the selected (e.g., structured) AI model. The IE may receive, from the network, a first portion of the selected AI model and execute the first portion of the selected AI model. The IE may receive, from the network, a second portion of the selected AI model and execute the second portion of the selected AI model. The IE may receive, from the network, a final portion of the selected AI model and execute the final portion of the selected AI model.

In certain representative embodiments, the WTRU 102 may perform a Service Announcement and Service and Content Discovery procedure with the network to obtain at least one of Service Access information and AI model streaming access information.

In certain representative embodiments, the WTRU 102 may select the AI model as a function of the WTRU's capabilities to run AI models and functional requirements of the candidate AI models.

In certain representative embodiments, the WTRU 102 may, responsive to the request, receive initialization information of the selected AI model content. For example, the initialization information may include configuration parameters for reception of the selected AI model.

### REFERENCES

Each of the contents of the following references is incorporated by reference herein: (1) 3GPP TS 26.501, “5G Media Streaming (5GMS); General description and architecture”, V18.0.0(01 -2023); (2) WG03N0148, “Text of ISO/IEC 14496-12 FDIS 7th edition ISO Base Media File Format”, MPEG #133, (01-2021); (3) RFC2045, “Multi-purpose Internet Mail Extensions (MIME) Part 1: Format of Internet Message Bodies”, IETF, November 1996; and (4) 3GPP TS 26.247, “Transparent end-to-end Packet-switched Streaming Service (PSS); Progressive Download and Dynamic Adaptive Streaming over HTTP (3GP-DASH)”, V17.2.0 (01-2023).

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

1. A wireless transmit/receive unit (WTRU) comprising:
a processor, memory, and a transceiver which are configured to:
receive, from an application provider, information indicating a set of artificial intelligence (AI) models and a set of addresses associated with the set of AI models,
send, to a network entity executing an application server, a request for an AI model using an address associated with the AI model from among the set of addresses,
receive, from the second network entity, information indicating the AI model content corresponding to the AI model, and
obtain a result using the received AI model content.

2. The WTRU of claim 1, wherein the processor, memory, and the transceiver are configured to establish a session with the network entity, and
wherein the AI model content is received from the network entity via the established session, and the AI model content corresponds to a full model of the AI model.

3. The WTRU of claim 2, wherein the processor, memory, and the transceiver are configured to configure an inference engine, executed by the WTRU, with the full model, and
wherein the result is obtained from the configured inference engine.

4. The WTRU of claim 1, wherein the processor, memory, and the transceiver are configured to establish a session with the network entity, and
wherein the AI model content is received from the network entity via the established session, and the AI model content corresponds to a one or more subsets of the AI model.

5. The WTRU of claim 4, wherein the processor, memory, and the transceiver are configured to configure an inference engine, executed by the WTRU, with each subset of the AI model, and
obtain one or more intermediate results obtained from the configured inference engine.

6. The WTRU of claim 5, wherein the processor, memory, and the transceiver are configured to provide each of the one or more intermediate results to an application executed by the WTRU.

7. The WTRU of any of claims 1-6, wherein the processor, memory, and the transceiver are configured to provide the result to an application executed by the WTRU.

8. The WTRU of any of claims 1-7, wherein the processor, memory, and the transceiver are configured to receive a selection of the AI model from the set of AI models.

9. The WTRU of any of claims 1-8, wherein the processor, memory, and the transceiver are configured to receive, from the application provider, decryption information associated with the AI model from an application provider, and decrypt the information indicating the AI model content using the decryption information.

10. The WTRU of any of claims 1-9, wherein the AI model content comprises a plurality of dynamic adaptive streaming over hypertext transfer protocol (DASH) segments, and wherein the processor, memory, and the transceiver are configured to aggregate the DASH segments to obtain the AI model.

11. The WTRU of any of claims 1-9, wherein the AI model content comprises one or more AI model files, and wherein the processor, memory, and the transceiver are configured to receive each AI model file as a plurality of sequentially executable subsets.

12. The WTRU of any of claims 1-11, wherein the processor, memory, and the transceiver are configured to:
send, to another network entity executing an application function, information indicating the AI model from among the set of AI models,
receive, from the other network entity, information indicating data encapsulation and/or compression format associated with the AI model, and
receive, from the other network entity, the information indicating the AI model content corresponding to the AI model based on the data encapsulation and/or compression format.

13. The WTRU of any of claims 1-12, wherein the processor, memory, and the transceiver are configured to receive the information indicating the AI model content as a bitstream.

14. The WTRU of any of claims 1-13, wherein the addresses are uniform resource locators (URLs) respectively associated with the set of AI models.

15. A method implemented by a wireless transmit/receive unit (WTRU), the method comprising:
receiving, from an application provider, information indicating a set of artificial intelligence (AI) models and a set of addresses associated with the set of AI models;
send, to a network entity executing an application server, a request for an AI model using an address associated with the AI model from among the set of addresses;
receiving, from the network entity, information indicating the AI model content corresponding to the AI model based on the data encapsulation and/or compression format; and
obtaining a result using the received AI model content.

16. The method of claim 15, wherein further comprising:
establishing a session with the network entity, and
wherein the AI model content is received from the network entity via the established session, and the AI model content corresponds to a full model of the AI model.

17. The method of claim 16, further comprising:
configuring an inference engine, executed by the WTRU, with the full model, and
wherein the result is obtained from the configured inference engine.

18. The method of claim 15, further comprising:
establishing a session with the network entity, and
wherein the AI model content is received from the network entity via the established session, and the AI model content corresponds to a one or more subsets of the AI model.

19. The method of claim 18, further comprising:
configuring an inference engine, executed by the WTRU, with each subset of the AI model; and
obtaining one or more intermediate results obtained from the configured inference engine.

20. The method of claim 19, further comprising:
providing each of the one or more intermediate results to an application executed by the WTRU.

21. The method of any of claims 15-20, further comprising:
providing the result to an application executed by the WTRU.

22. The method of any of claims 15-21, further comprising:
receiving a selection of the AI model from the set of AI models.

23. The method of any of claims 15-22, further comprising:
receiving, from the application provider, decryption information associated with the AI model from an application provider, and decrypt the information indicating the AI model content using the decryption information.

24. The method of any of claims 15-23, further comprising:
aggregate a plurality of dynamic adaptive streaming over hypertext transfer protocol (DASH) segments to obtain the AI model.

25. The method of any of claims 15-23, wherein the AI model content comprises one or more AI model files, and wherein each AI model file is received as a plurality of sequentially executable subsets.

26. The method of any of claims 15-25, further comprising:
sending, to another network entity executing an application function, information indicating the AI model from among the set of AI models; and
receiving, from the other network entity, information indicating data encapsulation and/or compression format associated with the AI model,
wherein the information indicating the AI model content corresponding to the AI model is received based on the data encapsulation and/or compression format.

27. The method of any of claims 15-24, wherein the information indicating the AI model content is received as a bitstream.

28. The method of any of claims 15-25, wherein the addresses are uniform resource locators (URLs) respectively associated with the set of AI models.
